(19) United States
(12) Patent Application Publication
(10) Pub. No.: US 2019/0187679 A1
(43) Pub. Date: Jun. 20, 2019

(54) Machine Monitoring

(71) Applicant: Weir Minerals Australia Ltd, Artarmon NSW (AU)

(72) Inventors: Craig Donald Strudwicke, Molong (AU); Michael Hambe, Artarmon (AU); Mark Janos, Artarmon (AU); Benjamin Michael Baker, Roseville (AU)

(21) Appl. No.: 16/301,900

(22) PCT Filed: May 16, 2017
(86) PCT No.: PCT/AU2017/050449

§ 371 Date: Nov. 15, 2018

(30) Foreign Application Priority Data
May 16, 2016 (AU) 2016901806

(51) Int. Cl. G05B 23/02; G05B 11/01; G05B 13/02

(52) U.S. Cl. CPC G05B 23/0283; G05B 23/0235; G05B 23/0221; G05B 15/02; G05B 11/01; G05B 13/026; G05B 23/0272

(57) ABSTRACT

Disclosed is a method for monitoring the operation of a machine. The method comprises measuring a plurality of parameters of the machine to obtain a plurality of measured values and transforming the measured values to generate a plurality of normalised indicator values. The method further comprises using the normalised indicator values to indicate a condition of the machine. Also disclosed is a method of managing the operation of a machine. The method includes measuring a plurality of parameters of the machine, predicting, based on historical data, a time at which the measured values will reach a replacement criterion, identifying one or more components of the machine that require to be replaced in order to prevent the replacement criterion being met, and communicating, to a service provider, an indication of the one or more components that require replacement.

### TECHNICAL FIELD

This disclosure relates to a method of monitoring a machine. The method finds particular, but not exclusive, use in industrial processing operations, such as in the minerals, power and mining industries.

### BACKGROUND ART

Machinery used in various operations, such as minerals processing, chemical, oil and gas, power generation etc. experience constant changes in their condition. This may be in the form of e.g. fluctuations in performance and/or degradation of various components of the machinery.

In regards to performance fluctuations, these may be caused by internal changes to the machine or external (e.g. environmental) changes. Such changes may require modification of various operating parameters of the machine to ensure that the performance of the machine is maintained within a suitable range. For example, a change in the consistency of material being processed by a hydrocyclone may require an adjustment of the inlet flow rate of the hydrocyclone.

Often such machinery operates in highly destructive conditions, whereby components of the machines may be worn away or pitted due to repetitive material impact. The degradation of one component can lead to imbalances in the machine that result in degradation of further components.

Both performance and life of a machine can have a direct impact on the costs of running an operation. If a machine fails it can result in the shutdown of an entire process. Similarly, machines running at sub-optimal performance levels can result in an inefficient process that consumes more energy than required. As such, there is a need to manage these conditions of a machine.

One known method of doing this is to have an operator observe a machine in person. The operator may view and listen to the machine, and may take various measurements of parameters of the machine. Based on experience working with such machines, the operator may be able to provide an estimate of how the machine is performing, and whether it requires replacement.

Such a method of monitoring machines relies on the operator's experience, and may ignore many operating parameters of a machine that are not readily available for measurement by the operator. This may lead to inaccuracies in the estimates made by the operator.

It is to be understood that, if any prior art is referred to herein, such reference does not constitute an admission that the prior art forms a part of the common general knowledge in the art, in Australia or any other country.

### SUMMARY

In a first aspect there is disclosed a method for monitoring the operation of a machine. The method comprises measuring a plurality of parameters of the machine to obtain a plurality of measured values and transforming the measured values to generate a plurality of normalised indicator values. The method further comprises using the normalised indicator values to indicate a condition of the machine.

In one embodiment the step of indicating a condition of the machine may comprise combining the normalised indicator values.

The term ‘normalised’ is not intended to require that the indicator values lie between 0 and 1. Rather, this term is used to define the indicator values as having a shared meaning, scale and/or unit of measure. That the indicator values are normalised facilitates their combination in order to provide a meaningful indication of the condition of the machine.

The indicated condition of the machine is established from an amalgamation of the measured values. In one form, the monitoring method may combine information from a plurality of sources into a single indication. This single indication of the machine condition may be easier for e.g. an operator to comprehend than the plurality of individual measured values.

In one embodiment the step of indicating the condition may comprise displaying the condition, in the form of a graphic, to a user. The graphic may be in the form of a chart, bar, etc.

In one embodiment the method may further comprise the step of controlling the machine in response to the indicated condition of the machine.

In one embodiment the step of controlling the machine may comprise an automatic adjustment of one or more operating parameters of the machine, by a controller, in response to the indicated condition of the machine. Such an arrangement may require minimal operator input.

In one embodiment the automatic adjustment may comprise ceasing operation of the machine.

In one embodiment the step of transforming the values may comprise combining one or more of the values of the measured parameters to generate combined values. This combination may be in the form of an addition or subtraction of the one or more values of the measured parameters. Alternatively the combination maybe a more complicated function that receives the values and provides a single combined value.

In one embodiment the step of transforming the values may comprise testing each measured value or combined value against a respective set of predetermined criteria.

In one embodiment each criteria may correspond to an indicator value. The generated indicator values may be those corresponding to criteria satisfied by the measured or combined value.

In one embodiment the criteria and corresponding indicator values may be adjusted upon completion of the method for subsequent repeat execution of the method. The criteria and indicator values may be optimised by way of this adjustment in order to arrive at a more accurate indication of the condition of the machine.

In one embodiment each set of predetermined criteria may comprise one or more predetermined ranges of values. The testing of the values or combined values may comprise testing whether the values fall within one of the predetermined ranges of values.

In one embodiment each indicator value may be indicative of an effect on the condition of the machine.

In one embodiment the indicator value may be indicative of an effect on a health condition of the machine, and the indicated condition may be a current health level of the machine.

In one embodiment the current health level of the machine may be indicated as a proportion of a maximum health level of the machine.

In one embodiment the method may further comprise the step of producing an alert when the current health level of the meets a predetermined threshold level. The alert may be a visual or audible alert. Alternatively it may be in the form of an alert signal that may be interpreted by a control system (for controlling the machine).

In one embodiment the method may further comprise identifying one or more components affecting the health level of the machine. Such an identification may, for example, be performed using known relationships between measured values and component wear, or by way of a machine learning or pattern-matching algorithms.

In one embodiment the one or more components may be identified by way of analysing the plurality of normalised indicator values. In some cases, the normalised indicator values may inherently contain information regarding the relevance of the measured value to a wear condition of the machine.

In one embodiment one or more operating parameters of the machine may be controlled in order to reduce the effect of the one or more identified components on the health level of the machine. This may be done, for example, to avoid catastrophic failure of a machine. For example, this may be at the expense of the overall efficiency or performance of a machine.

In one embodiment the method may further comprise identifying that one or more components require replacing and communicating replacement component information to a service provider, the replacement component information comprising information regarding the one or more components that require replacement.

In one embodiment the service provider may comprise an additive manufacturing facility, and the replacement component information comprises data allowing the additive manufacturing facility to produce the one or more required replacement components. The data may comprise one or more 3D design files. Alternatively or additionally the data may comprise access information for a server on which one or more 3D design files are stored.

In one embodiment the additive manufacturing facility may be geographically local to the machine. In this way, a replacement component may be produced in proximity to the machine and may not need to be transported to the machine. This may reduce the cost and time to replace a component of a machine.

In a second aspect there is disclosed a system for monitoring a machine. The system comprises a plurality of sensors and a processor. Each sensor measures a parameter of the machine and produces data indicative of the measured value of the parameter. The processor receives the measured value data, transforms the measured value data to generate a plurality of normalised indicator values, and uses the normalised indicator values to indicate a condition of the machine.

In one embodiment the system further comprises a controller to control the machine in response to the indicated condition of the machine.

In one embodiment the system further comprises a display to display the indicated condition, in the form of a graphic, to a user.

In one embodiment each indicator value may be indicative of an effect on the condition of the machine

In one embodiment each indicator value may be indicative of an effect on a health condition of the machine, and the indicated condition is a current health level of the machine.

In one embodiment the processor may be further configured to produce an alert when the current health level of the machine falls below a predetermined threshold level. The alert may be in the form of an alert signal to a controller or a processor, or may be visual or audial alert to an operator.

In one embodiment the processor may be further configured to identify one or more components of the machine that, if replaced, would return the health level of the machine to a level that is above the predetermined threshold level.

In one embodiment the one or more components may be identified by way of analysing the plurality of normalised indicator values.

In one embodiment one or more operating parameters of the machine may be controlled by the controller in order to reduce the effect of the one or more identified components on a health level of the machine.

In one embodiment the system may further comprise a service provider, the processor further configure to communicate replacement component information to the service provider, the replacement component information comprising information regarding the one or more identified components.

In one embodiment the service provider may comprise an additive manufacturing facility, and the replacement component information may comprise data allowing the additive manufacturing facility to produce the one or more required replacement components.

In one embodiment the additive manufacturing facility may be geographically local to the machine.

In a third aspect, there is disclosed a computer program comprising instructions for controlling a computer to implement a method as described above.

In a fourth aspect, there is disclosed a computer readable medium, providing a computer program as described above.

In a fifth aspect there is disclosed a data signal comprising a computer program as described above.

In a sixth aspect there is disclosed a machine comprising a plurality of machine functions, and a plurality of sensors measuring parameters of the respective machine functions and producing data indicative of the measured values of those parameters. The machine also comprises a visual display providing a visual scale representing conditions of the machine, and a processor that, in response to the measured values from the plurality of the machine components, indicates a current condition of the machine on said visual scale.

In one embodiment the plurality of machine functions may comprise one or more components of the machine and/or processes of the machine.

In one embodiment the processor may indicate the current condition by transforming the data indicative of the measured values to generate a plurality of normalised indicator values, and by using the normalised indicator values to indicate the current condition of the machine.

In one embodiment the step of transforming the data may be as otherwise described above with respect to the system.

In one embodiment the machine may further comprise a controller to control the machine in response to the indicated current condition of the machine.

In one embodiment the visual display may be remote from the sensors.

In a seventh aspect there is disclosed a system comprising a plurality of machines, and a plurality of sensors measuring parameters of the respective machines and producing data indicative of the measured values of those parameters. The system also comprises a visual display providing a visual scale representing collective conditions of the machines, and a processor that, in response to the measured values from the plurality of the machines, indicates a current collective condition of the machines on said visual scale.

In one embodiment the processor may indicate the collective current condition by transforming the data indicative of the measured values to generate a plurality of normalised indicator values, and by using the normalised indicator values to indicate the current condition of the machine.

In one embodiment the step of transforming the data may be as defined above.

In one embodiment the system may further comprise a controller to control the machine in response to the indicated current condition of the machine.

In one embodiment the visual display may be remote from the sensors.

In an eighth aspect there is disclosed a method for managing the operation of a machine. The method comprises measuring a plurality of parameters of the machine to obtain a plurality of measured values; predicting, based on historical data, a time at which the measured values will reach a replacement criterion; identifying one or more components of the machine that require to be replaced in order to prevent the replacement criterion being met; and communicating, to a service provider, an indication of the one or more components that require replacement.

The replacement criterion may, for example, be measured values that are indicative of the machine having no more remaining useful life. It may be desirable to avoid such an outcome in order to avoid or minimise downtime of a machine. The identification of components may take into consideration the predicted time until the measured values will reach a replacement criterion. The method may reduce the time and cost of maintaining equipment, and may reduce downtime of machines caused by unexpected component failure or wear.

In one embodiment, the method may further comprise the step of transforming the measured values to generate a plurality of normalised indicator values. The step of comparing the plurality of measured values with historical data may be a comparison of the normalised indicator values with the historical data.

In one embodiment the historical data may be data obtained from similar machines. The data may additionally or alternatively be obtained for machines in similar installations. The historical data may include time prior to failure.

In one embodiment the one or more components may be identified by way of analysing the plurality of measured values or normalised indicator values.

In one embodiment the method may further comprise controlling one or more operating parameters of the machine in order to reduce deterioration of the one or more identified components.

In one embodiment the method may further comprise communicating replacement component information to a service provider, the replacement component information comprising information regarding the one or more identified components.

In one embodiment the service provider may comprise an additive manufacturing facility, and the replacement component information may comprise data allowing the additive manufacturing facility to produce the one or more required replacement components.

In one embodiment the additive manufacturing facility may be geographically local to the machine.

### BRIEF DESCRIPTION OF THE DRAWINGS

Embodiments will now be described by way of example only, with reference to the accompanying drawings in which:

FIG. 1 is a schematic depicting a first embodiment of a system for monitoring a plurality of machines;

FIGS. 2A and 2B are a flow chart and schematic depicting a method of monitoring a machine;

FIG. 3 is a schematic depicting an exemplary process for indicating a health condition of a fracking pump;

FIG. 4 is a schematic depicting an exemplary process for indicating a health condition of a slurry pump;

FIG. 5 is a schematic depicting a second embodiment of a system for monitoring a plurality of machines and including an additive manufacturing facility; and

FIG. 6 is a flow chart depicting an exemplary process for responding to machine data.

### DETAILED DESCRIPTION

In the following detailed description, reference is made to accompanying drawings which form a part of the detailed description. The illustrative embodiments described in the detailed description, depicted in the drawings and defined in the claims, are not intended to be limiting. Other embodiments may be utilised and other changes may be made without departing from the spirit or scope of the subject matter presented. It will be readily understood that the aspects of the present disclosure, as generally described herein and illustrated in the drawings can be arranged, substituted, combined, separated and designed in a wide variety of different configurations, all of which are contemplated in this disclosure.

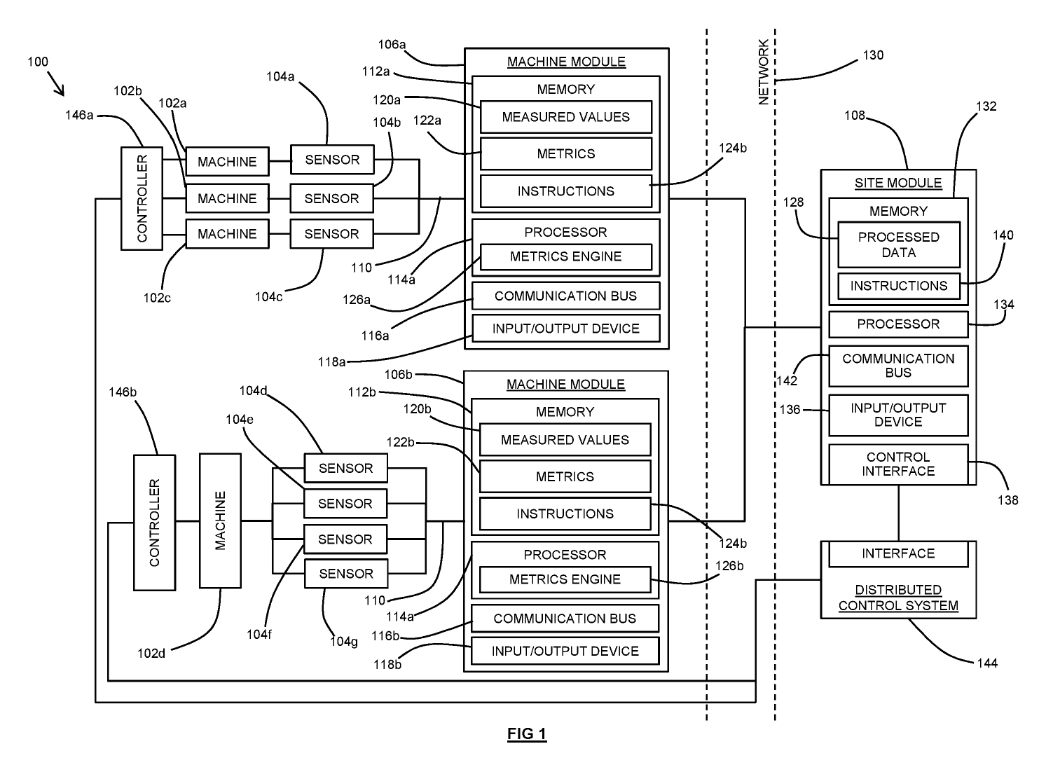

Referring firstly to FIG. 1, the system 100 broadly comprises a plurality of machines 102, a plurality of corresponding sensors 104, first and second machine modules 106, and a site module 108. To facilitate an understanding of the system, it will henceforth be described in the context of an exemplary minerals processing operation. However, it should be understood that the system is suitable for any operation in which multiple machines, or multiple parameters of a single machine, require monitoring.

The illustrated system comprises four machines 102. The machines may be in the form of any equipment that requires monitoring. In a general sense, the machines 102 may have moving components and/or may be used to process material such that the machines 102 exhibit changes in performance and/or wear over time or in response to changing processing conditions. For example, each machine 102 may be one of, a hydrocyclone, centrifugal slurry pump, positive displacement pump, commination equipment, etc.

In the presently illustrated form, three of the machines (the first 102a, second 102b and third 102c machines) are each associated with single a respective sensor 104a, 104b, 104c. One of the machines (the fourth machine 102d) is associated with four sensors 104d, 104e, 104f, 104g. This association may be in the form of a structural connection between the sensor 104, but this is not necessary as long as the sensor 104 is arranged to measure a parameter that relates to the operation of the machine 102. Each sensor 104 may be mounted to a component of its respective associated machine 102 (or mounted in proximity to the machine 102), or may be mounted to a component that interacts with the machine 102 in some way. For example, a flowmeter measuring the flow of fluid into a pump may not necessarily be mounted to the machine 102 (it may be mounted at a distance, to an inlet pipe), but this sensor is still associated with the machine 102, because it is measuring a parameter (inlet flow) of the machine 102. In another example of a non-direct association, a sensor 104 may be configured to monitor the current supplied to a motor of a machine 102. Although the sensor 104 would not necessarily be mounted to the machine 102 (or even in the vicinity of the machine) it would still be associated with the machine 102 as the measurement of current could be used to monitor the efficiency of the machine 102.

The sensors 104 are able to measure various parameters of their respective machines 102. Such parameters may include temperature, pressure, vibration, voltage, current, rotation speed, etc. of various components, process fluids, or the surrounding environment. In this respect, the sensors 104 may take any suitable form for measuring such parameters—the sensors 104 may be accelerometers (single-axis or tri-axial), flowmeters, speed sensors, voltage detectors, temperature probes, pressure transducers, strain gauges, etc. Each sensor 104 may measure its respective parameter in a discrete or continuous manner and, from these measurements, can produce data that is indicative of the measured values of the respective parameters they are configured to measure. This data is communicated in the form of a signal (e.g. a voltage level) to the machine modules 106 via a wired and/or wireless connection 110 between the sensors 104 and the machine modules 106.

The sensors associated with the first 102a, second 102b and third 102c machines communicate their data (i.e. measured values) to the first machine module 106a, whilst the four sensors 104d, 104e, 104f, 104g associated with the fourth machine 102d communicate their respective data to the second machine module 106b. This arrangement of machines 102 and machine modules 106 may be selected as a result of a shared characteristic between the first 102a, second 102b and third 102c machines (i.e. that is not shared by the fourth machine 102d). This characteristic may, for example, be the location of the machines 102, the type of machines 102, the material that the machines 102 are processing or a combination of these characteristics. For example, the first 102a, second 102b and third 102c machines may be hydrocyclones forming part of a hydrocyclone cluster and the fourth machine 102d may be a centrifugal slurry pump. In this way, data that is received and handled by the first machine module 106a only concerns parameters of the hydrocyclone cluster, and data handled by the second machine module 106b only concerns parameters of the centrifugal pump. This limits the outputs of these machine modules 106 to indications of the operating conditions of the hydrocyclone cluster and centrifugal pump respectively and this clear separation of functions may prevent confusion or cross-over of data between machine types or locations. In another form that is not illustrated, all of the machines may share a single central machine module rather than being split between designated machine modules.

Each machine module 106 comprises a memory 112, processor 114, communication bus 116 and input/output (I/O) device 118. These components may be enclosed in a housing that can be located in proximity to the sensors that the machine module 106 receives data from. Such positioning may limit the length of wiring between the machine module 106 and the sensors 104, or in the case of a wireless connection, may avoid interference of signals. The housing and/or components of the machine module 106 may be adapted (e.g. by way of waterproofing, shade, etc.) so as to be particularly suitable for use with a particular type of machine 102 or in a particular location.

Each machine module 106 receives data, in the form of measured parameter values, from the sensors 102 (via the I/O device 118) and stores the measured values 120 in the memory 112. Also stored in the memory 112 is a set of metrics 122 that correspond to the measured parameters, and instructions 124 that specify how the measured values 120 are to be handled with respect to the metrics 122. The memory 112 may comprise any known memory architecture and may include hard disk, IC memory (ROM, PROM, RAM, etc.), floppy disks, CD ROM, and any other type of memory.

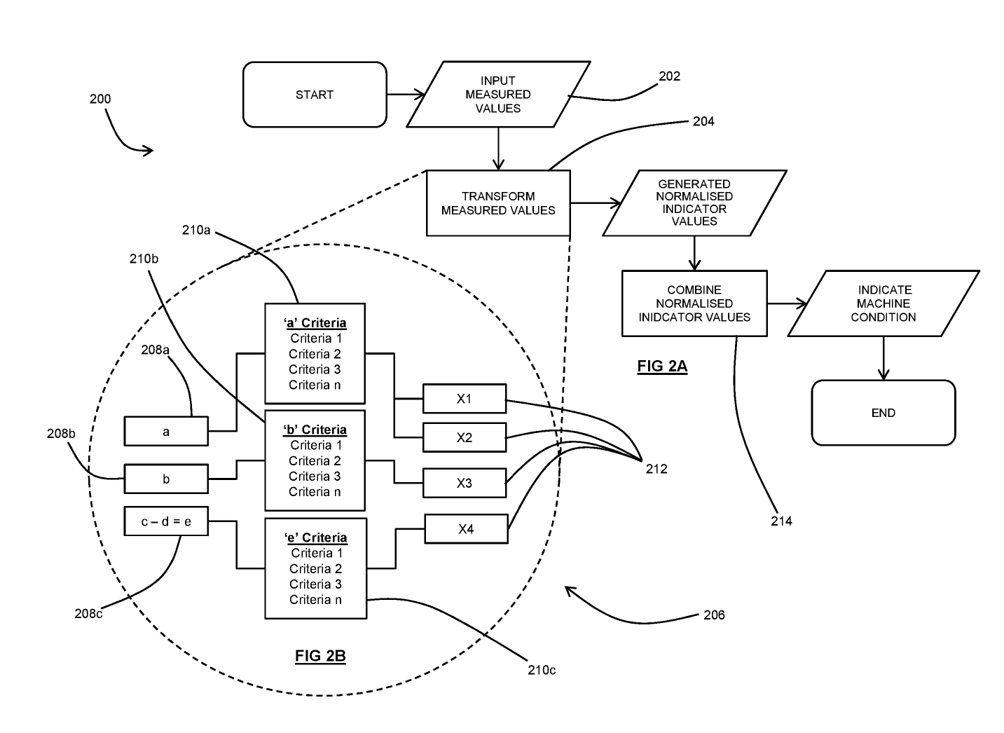

The processor 114 may constitute one or more processing means (e.g. integrated circuit processors) and comprises a metrics engine 126 that can process the stored measured values 120 according to the stored instructions 124 and using the stored metrics 122. Operation of the metrics engine 126 will be described in more detail with reference to FIGS. 2A and 2B below. The communication bus 116 facilitates the processing of the stored measured values 120 by the processor 114 by enabling communication between the processor 114 and the memory 112, and between the machine module 106 and external components of the system 100.

Data that has been processed by the processor 114 (i.e. processed data 128) is communicated from the machine modules 106 to a site module 108. This communication is facilitated by a network, which in the presently illustrated embodiment is a secured wireless network 130. A wireless (as opposed to a wired) network may be preferred on large sites where distances between the machine modules and the site module can be large (such that a wired network would require extensive wiring). The secured wireless network 130 may be a secured WiFi network, and the I/O devices 118 of the machine modules 106 may each comprise a modem and antenna (omni-directional or directional) to enable communication over the WiFi network.

Use of the wireless network 130 may allow further access (in addition to the site module 108) to each machine module 106. For example, processed data 128 may be accessed by an operator using a mobile device (e.g. laptop, tablet, mobile phone, etc.) in proximity to a respective machine 102. The operator may, for example, wish to observe the processed data 128 (provided by the machine module 106) whilst being able to view and/or listen to the machine 102.

The site module 108, which may be located at a central site office, comprises a memory 132, processor 134, I/O device 136 and an interface 138. The memory 132 and processor 134 may take similar forms to that described above with respect to the machine modules 106. The processed data 128 that is received from the machine modules 106 is stored in the memory 132 of the site module 108 along with instructions 140 for handling the processed data 128. The I/O device 136 comprises a display which allows information or data to be displayed in a graphical format. The display may be in the form of a touchscreen so as to provide user input and enable a user to control the information that is being displayed by the display. Other user input means may also be present, such as a keyboard, mouse, buttons, switches, etc. Where a display is not present, the data from the machine modules may be indicated by way of indicator lights and/or audible alarms.

The processed data 128 may be retrieved by the processor 134 and communicated, via a communication bus 142, to the display. Display of the processed data may allow an operator at the site module 108 to respond to the measured values 120 of the parameters of the machines 102 when required. Alternatively or additionally, the processor 134 may retrieve the processed data 128 from the memory 132 and communicate it, via the interface 138, to a distributed control system 144. The distributed control system 144, among other features, is able to communicate with controllers 146 that are able to control the corresponding machines 102 in response to the processed data 128 stored in the memory 132 of the site module 108.

The flow chart and schematic shown in FIGS. 2A and 2B depict a method 200 for monitoring machine. This method 200 may be performed using the system 100 as set forth above, but is not limited to such a system 100. It would be apparent to the skilled person that other system architectures would be suitable for enabling such a method 200 to be performed. For example, the plurality of sensors may all communicate with a single central machine module. That central machine module may comprise a display for indicating a machine condition to an operator, and may additionally comprise an interface with a distributed control system for controlling the machines accordingly.

Regardless, for clarity the method 200 will be described with reference to the system architecture discussed above. In this respect, the method 200 may be performed by the processors 114 of the machine modules 106, using their respective metrics engines 126. Hence, the method 200 shown in FIGS. 2A and 2B may be broadly representative of the instructions 124 stored in the memory 112 of the machine modules 106.

The first step of the method 200 is performed by a receiver process 202 of the metrics engine. The receiver process 202 receives the measured values (measured from the various sensors) from the memory. As set forth above, these measured values are each indicative of a parameter of the machine (or a parameter of a cluster of machines) at a point in time or over a period of time. As is also set forth above, some example of these parameters include vibration, pressure, temperature, power, etc.

These measured values are then handled by a transformer process 204 of the metrics engine in a transformation step. An example of this transformation step 206 is illustrated in FIG. 2B. Although only one example is illustrated, this transformation step 206 may involve any of a number of transformations, including combining various measured values to form combined values (e.g. subtracting one measured value from another to provide a value representative of the difference between he measured values). The present example involves a comparison of measured and combined values 208 with a set of a criteria 210, but in other forms this transformation may be a function applied to the measured values to arrive at normalised indicator values.

The exemplary transformation step involves two measured values 208a, 208b and one combined value 208c. The combined value 208c, in the illustrated form, is a computed difference between two measured values. The transformation step 206 includes a comparison process in which each of the measured 208a, 208b or combined 208c values is compared with a respective set of criteria 210. In this embodiment each set of criteria 210 is specific to its respective measured 208a, 208b or combined 208c value, but in other forms some criteria may be shared between values (e.g. where two values represent temperatures at different positions on the machine).

Each criteria 210 may be in the form of a range of values that the respective measured or combined values may take. For example, one of the parameters may be the amplitude of vibration of a housing of a machine, and the criteria may be in the form of ranges of vibrations that the housing may exhibit in operation.

The output of the transformer process 206 is a plurality of normalised indicator values 212. These indicator values 212 are generated by the comparison of the measured 208a, 208b and/or combined 208c values with the criteria. Each criteria is associated with a corresponding indicator value 212 and, when a criteria is satisfied by the measured 208a, 208b or combined 208c value (e.g. when the measured 208a, 208b or combined 208c value falls within the range of values designated by the criteria), the associated indicator value 212 is generated as an output by the transformer process 206.

The selection of criteria and associated indicator values 212 will vary between machine types, and sometimes between installations (e.g. due to location, environment, etc.) of those machines. Hence, particular criteria and associated indicator values 212 may need to be selected or set up for a machine on installation of the machine. The selection of indicator values 212 may be at least partially based on how they are combined in order to arrive at the indication of the machine condition. Where the indicator values 212 are summed to provide the machine condition, the magnitude of the indicator values 212 may be representative of the corresponding parameters significant in the indication of the machine condition. In any case, the selection of these aspects of the method will differ between machines and parameters.

For some machines or parameters, a standard set of criteria and indicator values 212 may be acceptable, but where they are not, these aspects may be determined from historical data of the operation of the machine. This historical data may be in the form of previous machine condition indications by the method for other installations of the same machine type. Additionally, the criteria and indicator values 212 may be updated over time (i.e. subsequent to installation) based on a determination of how accurate the method 200 is in estimating the condition of the machine. This determination may, in its simplest form, be an operator adjusting the criteria and indicator values 212 based on personal judgement (e.g. using past experience) of the accuracy of the method 200. Alternatively, this determination may be performed using more complicated means, such as a machine learning process.

In the illustrated embodiment, two criteria are satisfied in the comparison of the first set of criteria 210 with the first measured value 208a, and only one criteria is satisfied by each of the second and third comparisons. This results in a total of four normalised indicator values 212 that share a common scale or unit of measurement (i.e. they share a common underlying meaning with respect to the machine condition).

That these values are normalised facilitates their combination with one another. As set forth above, the term ‘normalised’ does not necessitate that the indicator values 212 fall between 0 and 1. Rather it requires that the indicator values 212 share a common scale or unit of measurement (e.g. percentages). Each indicator value 212 is indicative of an effect on the condition of the machine. For example, when the method 200 is used to indicate a health condition of the machine, the indicator values 212 may each be indicative of a partial detriment to the health of the machine. Alternatively, when the method 200 is used to indicate a performance condition, the indicator values 212 may each be indicative of a probability that the machine is operating ideally or optimally.

Once generated, the normalised indicator values 212 are combined by a combiner process 214 of the metrics engine. Following on from the examples provided above, where the indicator values 212 are an indication of an effect on health, their summation may be indicative of a total effect on the health of the machine. Where the indicator values 212 are each indicative of a probability of the machine operating at an ideal condition, their weighted average may provide a more accurate, combined indication, of the operating condition of the machine.

In other words, the combination of the normalised indicator values 212 (by the combiner process 214) provides a single indicator of a condition of the machine based on the measured values of a plurality of parameters. This reduces the information that must be processed by an operator in order to ensure that a machine is operating suitably or does not have a detrimental health condition. Such a reduction in required attention may result in better management of the control of the machine and the replacement of components.

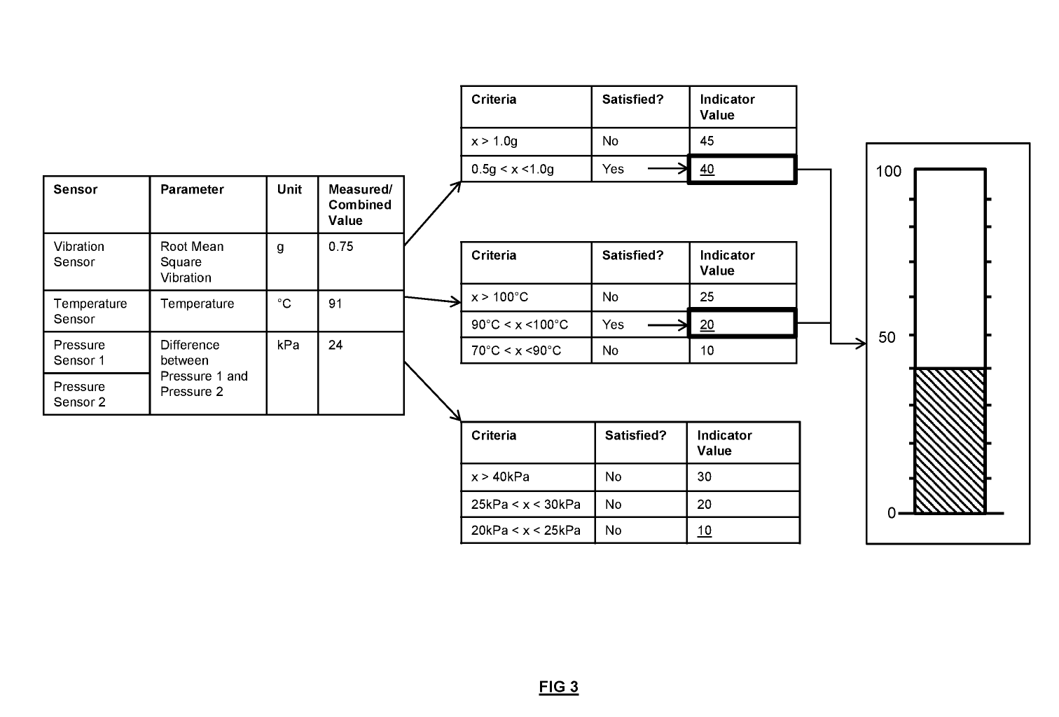

FIG. 3 shows an example of the method used to indicate a health condition of a fracking pump (or ‘frac pump’) in an oil and gas operation. The pump comprises a vibration sensor (in the form of an accelerometer) mounted to the housing, a temperature probe to measure fluid temperature, and two a pressure sensors to measure fluid pressure at two separate locations in the pump.

Each of the four sensors continuously measures its corresponding operating parameter of the pump and communicates the measured values to a machine module for storage and processing by the processor of the machine module. In an initial step the transformer process of the metrics engine (of the processor) combines the two measured pressure values by subtracting the pressure measured by the first pressure sensor from the pressure measured by the second pressure sensor. In the illustrated example the combined value is 24 kPa.

The transformer process subsequently compares the measured and combined values with the criteria stored in the memory. As is apparent from the figure, the criteria are in the form of adjacent ranges of values. Because the ranges do not overlap, the criteria are mutually exclusive. That is, the measured or combined values can only satisfy one, or none, of the criteria. In this respect the upper limits of each range could be considered threshold values. That is, once the measured value exceeds (or falls below) one of these threshold values it satisfies a different criteria. In the illustrated embodiments these threshold levels generally correspond to levels of impact on the health of the pump. For example, when the root mean square (RMS) of the vibration signal exceeds 0.5 g it may be indicative of a moderate impact in regards to the health of the pump, and when it exceeds 1.0 g it may be indicative of a critical impact on, or issue with, the pump. The value indicators, which are generated in response to satisfied criteria, are selected accordingly (i.e. a critical impact is associated with a higher indicative value than a moderate impact). This is discussed further below.

Each measured or combined value is compared with its own separate set of criteria. The transformer process compares the measured value from the vibration sensor with two corresponding criteria, which are in the form of two adjacent ranges. In the illustrated case, the measured value is lower than the values of the first range, so it does not satisfy the first criteria. However, the measured value does fall within the range of values designated by the second criteria (e.g. suggesting a moderate impact on the health of the pump). This second criteria is associated with an indicator value of 30, which is generated as an output by the transformer process.

The comparison of the measured value of the temperature sensor follows a similar procedure. The measured temperature value of 91° C. falls within the range designated by the second criteria, which is associated with an indicator value of 30. The third comparison is of the combined pressure difference value. This combined value does not satisfy any of the criteria in the corresponding set of criteria. As a result, no indicator value is generated by the transformer process of the metrics engine. Hence, the combined value (measured by the pressure sensors) may be suggestive of the pump operating in a healthy condition.

As may be apparent from a review of the tables of criteria, the indicator values are normalised so as to share a common scale or unit of measure—they share a common meaning. In the present case, each indicator value is representative of a reduction of health of the machine and, in particular, corresponds to a percentage health reduction. The measured values of RMS vibration and temperature are each indicative that the machine is not at full health—they suggest some reduction in the health of the machine. Specifically, these two measured values return indicator values of 40% and 20%, which represent corresponding reductions in the estimated health condition of the pump.

One benefit of returning normalised indicator values is that it facilitates their combination into a meaningful result. In the present example, the summation of the indicator values is representative or indicative of an overall health reduction of the machine (as a percentage) based on the measured parameters. This allows the health of the frac pump to be indicated in a number of different ways. In the present case, the current health condition of the pump is indicated in the form of a health bar. The full height bar is representative of the pump at a full health (i.e. ideal or optimal) condition. The hatched bar, which extends along a portion of the full height bar, represents the current health of the pump based on the values of the measured and combined parameters. The size of the current health bar is determined by deducting the indicator values from a total health value (i.e. 100%). The representation of current health as a proportion of full health allows an operator to quickly and easily gauge the current health condition of the machine. Where an operator is in control of a number of machines this can reduce tens or hundreds of measured parameters into a small number of graphics to be monitored by the operator and to be responded to, if required.

This health bar may be displayed to an operator of the pump on a display in a control room located at the site of the oil and gas operation. It may alternatively be displayed on a mobile device, or on non-mobile device that is remote from the operation.

What is not apparent from the Figure is that, because the parameters are continuously measured, the ‘health bar’ is updated in real time. For example, the RMS vibration increase from 0.75 g to 1.2 g so as to now fall within the higher range associated with an indicator value of 45. At the same time, the temperature may fall from 91° C. to 75° C. so as to lie within the lowest criteria range associated with an indicator value of 10. Although the RMS vibration increases, the reduction of the temperature means that the overall result is a drop in the total of the indicator values—this results in an increase in the estimated health condition of the pump. This example highlights that, because the estimate of current health is based on a plurality of measured parameters, it may provide more accuracy than if one were to focus on one or two parameters (as may be the case when diagnosing health issues based on observation and/or sound).

The real time nature of the method provides a way in which to observe changes in the health condition of the pump over time (i.e. if the health bar suddenly falls, it may be apparent to the operator that the machine is experiencing rapid degradation). This may enable a basic measure of approximately predicting remaining useful life of the machine (in this case, the pump).

If the health bar reduces to a certain threshold health value the operator may respond by inspecting the machine, reviewing the measured parameters, adjusting an operating parameter of the machine and/or ceasing operation of the machine (e.g. to prevent damage to the machine). Alternatively or additionally, the indicated health condition (i.e. the combination of indicator values) may be communicated to a control system. The control system may respond to the indicated health condition by adjusting an operating parameter of the pump, or by ceasing operation of the pump completely.

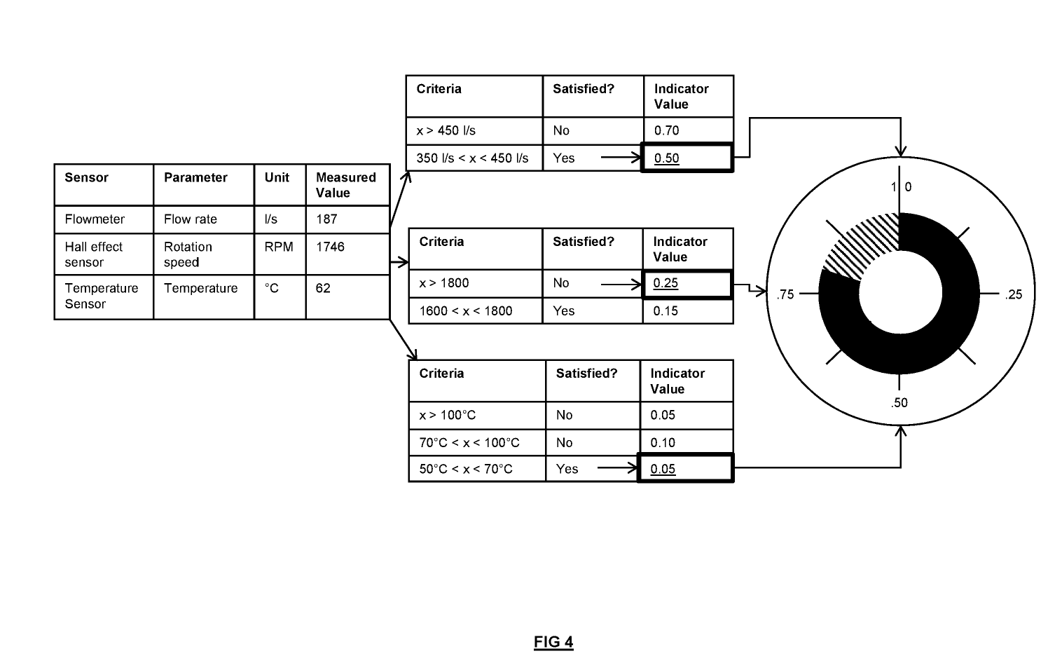

FIG. 4 shows an example of the method used to indicate a performance condition of a centrifugal slurry pump in an oil and gas operation. The pump comprises a flowmeter to measure a flow rate of fluid in the pump, a Hall effect sensor to measure rotation speed of a shaft of the pump, and a temperature sensor to measure a temperature of the casing of the pump.

As in the previously described example, each of the sensors continuously measures its corresponding operating parameter of the pump and communicates the measured values to a machine module for storage and processing by the processor of the machine module. In this example, none of the measured values are combined by the transformer process to form a combined value.

The transformer process compares the measured values with the criteria stored in the memory of the machine module associated with the slurry pump. Again, the criteria are in the form of adjacent ranges of values.

Each measured or combined value is compared with its own separate set of criteria. The transformer process compares the measured value from the flowmeter with two corresponding criteria ranges. In the illustrated case, the measured value is lower than the values of the first range, so it does not satisfy the first criteria. However, the measured value does fall within the range of values designated by the second criteria, which is associated with an indicator value of 0.30. Unlike the previously described example, the present method is for indicating a performance condition of the slurry pump. Hence, the indicator value of 0.3 is an indicator of an effect on the performance of the pump.

The comparison of the measured value of the Hall effect and temperature sensors follows a similar procedure. The measured rotation speed of 1746 RPM falls within the range designated by the first criteria, which is associated with an indicator value of 0.25. The measured temperature of 62° C. falls within the lowermost criteria range, which is associated with an indicator value of 0.25.

As discussed above, each indicator value is representative of an effect (e.g. contribution) on the performance condition of the machine. When combined, the indicator values provide an estimate of the current performance of the machine. In this respect the indicator values corresponding to the criteria for a measured parameter may be reflective of that measured parameter's significance with respect to the overall performance of the machine. For example, the indicator values for Temperature (0.05, 0.10, 0.05) are much lower than those for flow rate. This may suggest that the correlation between flow rate and pump performance is higher than the correlation between temperature and pump performance.

In the present case, the current performance of the pump is indicated in the form of a donut shaped bar. The full circle of the bar is representative of the pump operating at ideal or optimal performance. The black portion of the bar, which extends partway around the ‘donut’, represents the current performance of the pump based on the values of the measured and combined parameters. The extent to which the performance bar extends around the donut is determined by summing the indicator values (in this case providing a total of 0.80). This representation of performance provides an operator with a simplified way of identifying the performance level of the pump in relation to ideal performance. The current displayed current performance in the present example may e.g. be representative of the current performance being 80% of ideal performance.

As per the previously described example, the performance bar may be displayed to an operator of the pump (on a monitor, mobile device screen, etc.) or, the sum of indicator values may be communicated to a controlling system for suitable control of the pump.

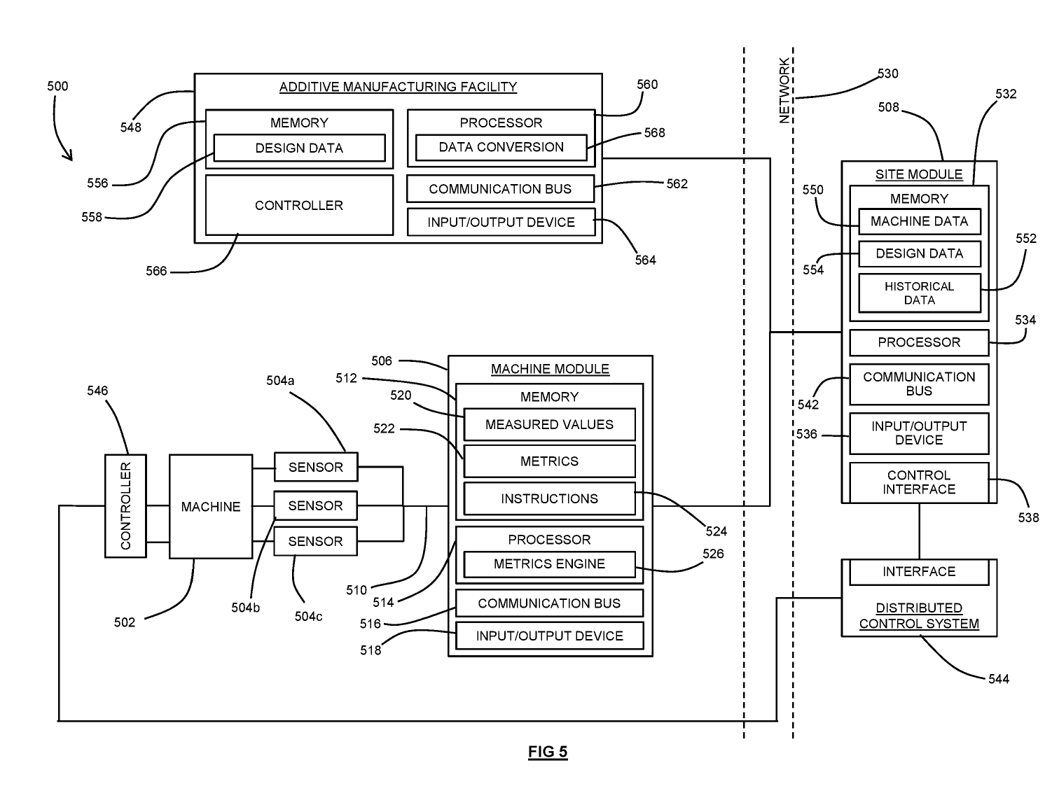

FIG. 5 illustrates a variation 500 of the system 100 described above and depicted in FIG. 1. For this reason, corresponding reference numerals have been used. The foremost difference between these systems 100, 500 is the further inclusion of an additive manufacturing facility 548 in the presently illustrated system. For illustrative purposes, minor modifications have been made to the illustrated site module 508 (e.g. such as the data stored by the memory 532 of the site module 508). However, it should be apparent to the skilled person that the site module 508 can, at least structurally, be the same as that shown in FIG. 1 and, in this respect, the presently illustrated embodiment may simply form an extension of the embodiment shown in FIG. 1.

In summary, the presently illustrated embodiment includes a machine 502, a plurality of sensors 504a, 504b, 504c measuring parameters of the machine 502, and a machine module 506 to receive measured values 520 from the plurality of sensors 504a, 504b, 504c. The machine module 506 includes the same components as described previously. In operation, the machine module 506 processes data received from the sensors 504a, 504b, 504c and transmits, to the site module 508, one or more of measured values 520, normalised indicator values, or an indicated condition of the machine 502. These are received by the site module 508 and stored in the site module memory 532 in the form of machine data 550.

The processor 534 of the site module 508 is configured to retrieve the machine data 550 (i.e. measured values, normalised indicator values, or indicated condition) from the memory 532, to process the machine data 550. The way in which the machine data 550 is processed depends on the type of the machine data 550 that is retrieved. However, in each case the output from the processor 534 may be an indication of one or more components of the machine 502 that are affecting the overall health of the machine 502 (i.e. so as to require maintenance). The outcome may similarly be an indication of the expected useful remaining life (RUL) of one or more components of the machine 502, or information relating to how the machine 502 may be operated differently (e.g. by the controller 546) to achieve a defined outcome. One defined outcome may be to maximise the life of a component, another defined outcome may be to maximise the efficiency of a component, and a third defined outcome may be to operate the machine 502 at its maximum capacity or performance.

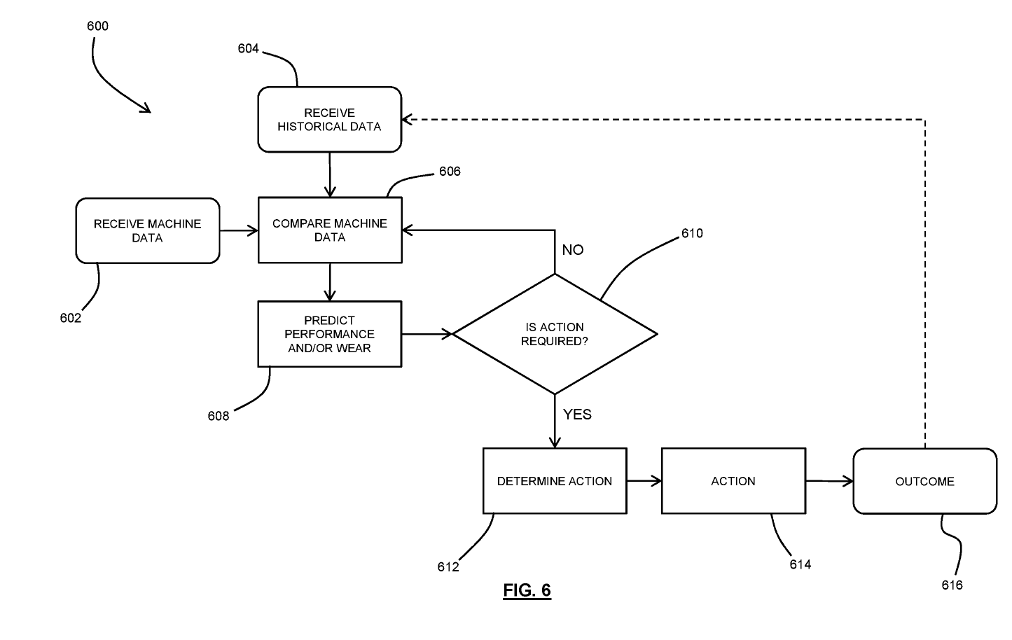

A more thorough explanation of this process is provided below with respect to FIG. 6, but broadly speaking, the process undertaken by the processor 534 can include a comparison of the values received from the machine module 506, with historical data 552 (e.g. for similar machines in similar installations). This historical data 552 is also stored in the memory 532 of the site module 508, and can be received and stored by the site module 508 on a continuous basis from various other (e.g. external) machines connected to the site module 508 (i.e. such that the volume of historical data increases over time). The site module 508 may additionally alternatively receive the historical data from a manual upload, or from a network connection to an external sever (e.g. a cloud-based server). In this respect, the historical data 552 may relate to the particular machine being monitored, or it may include sensor data from similar machines deployed in the same site, or even similar machines deployed in other sites. The historical data 552 may comprise sensor readings (normalised or raw) recorded prior to and during a failure mode of a component that those sensor readings relate to.

As set forth above, the desired output of the process (performed by the processor 534 of the site module 508) can take many forms. As discussed above, one desired output may be an indication of a component of the machine 502 that requires maintenance (of some form). In practice, this maintenance can be an adjustment to one or more components of the machine 502, a supply of a consumable (e.g. lubrication) to one or more components of the machine 502, or a complete replacement of one or more components of the machine 502.

The memory 532 of the site module 508 further includes design data 554 for a plurality of machine components. When the processor 534 of the site module 508 identifies that one or more components of the machine 502 require replacement, it retrieves corresponding design data 554 for these components from the memory 532 (e.g. via the communication bus) and transmits the design data 554 to the additive manufacturing facility 548. As should be appreciated by the skilled person, this transfer of data may occur over a wireless or wired network 530. The additive manufacturing facility 548 comprises a memory 556 for receiving and storing the design data 558, which is in the form of information for constructing (i.e. via additive manufacturing) a component associated with the design data 558.

In other embodiments, the design data for machine components may be located at a remote location. The site module 508 may request, from the remote location, a download of the design data file for a particular component to be replaced. The remote location may issue the design data file (e.g. in return for payment). Alternatively, the design data file may be stored in the memory of the site module, but in a locked or secure (i.e. inaccessible) form, and a validation code may be provided by the remote location to enable the design data file to be accessed and used.

The additive manufacturing facility further comprises a processor 560, communication bus 562, input/output device 564, and a controller 566. The processor can retrieve the design data 558 from the memory 556 (e.g. via the communication bus 562) and convert it to an appropriate format for the controller 566 of the additive manufacturing facility 548 (if the design data file is not already in the correct format) using a conversion engine 568. The processor 560 then communicates the converted data to the controller 566, which controls various components of the additive manufacturing facility 548 to produce the replacement machine component associated with the data 558. The additive manufacturing facility 548 may be made up of a number of separate ‘printers’ that may each be particularly suited for producing a particular component, or a set of components (e.g. being formed of the same material or being a similar shape or size). In this respect, although the additive manufacturing facility 548 has been illustrated with a single controller, 566 it should be appreciated that multiple controllers (e.g. one per printer) may be instructed by one or more processors.

The additive manufacturing facility 548 may be located proximate (i.e. geographically local to) the machine 502. In this way, once the replacement machine component is manufactured, it can be installed without needing to be transported from a separate manufacturing facility. This reduces the costs and time involved in replacing a component in a machine 502, and may minimise downtime of a machine.

In some cases, for example where a replacement component is large and complex, it can take significant time to manufacture the component. In other cases, there may be a desire to minimise the number of replacement components that are manufactured (i.e. by attempting to increase the life of the components installed in the machine 502). In such cases, the processor 560 may be configured to transmit instructions (via the distributed control system 544) to a controller 546 of the machine 502. These instructions may be to modify one or more operating parameters of the machine 502, which may be chosen to prolong the working life of a component (i.e. by reducing the stress or wear on a component). By prolonging the working life of the component, the machine 502 may remain in an operating condition whilst a replacement component is being produced by the additive manufacturing facility 548.

Although the embodiments described above relate to a hierarchical configuration (machine modules 506 being coupled to a site module 508), in other embodiments, machine modules from multiple sites may be coupled directly to a central monitoring system that aggregates sensor information from a large number of machine modules over multiple sites, optionally located in multiple geographic locations. This would be analogous to an Internet of Things (IoT) approach to monitoring the individual machines.

FIG. 6 illustrates a general process 600, making use of machine data, to determine 612 or recommend an action 614 to be taken such that a desired outcome 616 can be met. As set forth above, desired outcomes 616 may be performance based (e.g. optimisation of machine performance, or of component efficiency) or may be wear based (e.g. remaining useful life of a component or machine). Such a process may, for example, be performed wholly or partially by a processor (such as the site module processor described with respect to FIG. 5). For clarity, the presently illustrated process 600 will be described in the context of the system 500 described in FIG. 5. However, and as should be apparent to the skilled person, the process may be performed by any suitable system (e.g. including the system 100 depicted in FIG. 1).

The processor receives machine data 602 and compares that data to historical data 606. The received machine data 602 may be pre-processed, and may not necessarily be raw data received from sensors monitoring the machine. For example, the machine data 602 may include normalised indicator values that may be ascertained using one of the methods previously described. In some cases, especially for a simplistic comparison of data, the use of normalised indicator values may facilitate the present process 600.

The comparison 606 may be, for example, performed using a machine learning algorithm (e.g. random forests, support vector machines, logistic regression, artificial neural networks, etc.). Such an algorithm may be particularly suited to comparisons involving large volumes of data. For example, the processor may make use of a machine learning algorithm that is configured to perform a regression task to predict a remaining useful life for the machine. To do so, the machine learning algorithm may be trained using historical data 604 that includes sensor data for a time period (e.g. over the life of a component) and a remaining useful life value (or time until failure) that can be determined based on information regarding failure of each machine (i.e. by counting back from the failure time) forming part of the dataset. In this way, the machine learning algorithm can take the machine data as an input and return a prediction 608 of the remaining useful life of the machine.

Other various numerical methods may be used alone or in combinations with machine learning algorithms to predict 608 performance or wear conditions (or characteristics) of a machine. For example, an indicated performance condition of the machine be received as part of the machine data. The indicated performance condition may be determined using a process such as that illustrated in FIGS. 2A and 2B. The condition may be compared against a predetermined threshold condition (which itself may be based on historical data). If the indicated condition is above (or below) the predetermined threshold, it may be an indication of a wear issue with the machine, and an alert or warning may be provided. In response to such an alert, the machine may be further investigated. For example, a machine learning algorithm may be used to make a prediction of which component (or combination of components) is likely to be causing the loss in performance. In this case, the machine learning algorithm may be trained using historical data that includes sensor data and information regarding component failure or wear (and, in particular, which components are worn or have failed). In this way, the machine learning algorithm may be configured to perform a classification task to predict 608 which components of the machine may require replacement.

In one version of the system, the prediction 608 may be performed entirely using the normalised indicator values from the machine (i.e. such as those discussed with respect to FIG. 2). These normalised values inherently contain information in regards to the contribution of the parameter to the machine health, and thus may provide a simplistic way in which to predict wear of components of the machine.

Taking the embodiment shown in FIG. 4 as an example, and assuming a machine health threshold of 0.9, the following is an example of how such an identification process may operate. The current health condition (of the illustrated embodiment) is 0.8, which is below the exemplary threshold of 0.9 and, thus, the processor identifies that one or more components are not operating at peak performance levels. The processor then analyses the indicated values to identify which of the indicated values could be raised to increase machine health above the threshold. In the present case, either the flow rate or temperature indicator values may be raised (to 0.70 or 0.10) respectively to achieve such an outcome. Using built-in processes, the processor can identify one or more components that have a direct relationship with the identified indicator values and, by doing so, can make a prediction of components that are worn and that may require replacement. For example, a low flow rate may be indicative of a worn impeller in a pump, such that replacing the impeller, may increase the indicator value associated with flow rate.

In any of these scenarios, the outcome is, in essence, a prediction 608 of performance and/or wear of the machine. In the case of wear it may be a prediction 608 of when the machine may fail, and when a replacement component may be required to avoid such failure (i.e. when the replacement criterion is met).

To use such information, the processor is further configured to determine whether an action is required in response to the prediction 610. To process such a decision the processor can take various factors into consideration. One such factor can be in the form of a replacement criterion, such as a threshold health or performance level, or a remaining useful life threshold. In some embodiments, these threshold conditions may be updated in real time, either by a site module or by a central monitoring system (that may be coupled to many different site modules). This has the advantage of being able to select a threshold condition dynamically based on current operating or environmental conditions at a particular location or other indicia or conditions. Where a threshold is not met, the processor may take no action (i.e. and can continue to monitor the machine data). On the other hand, where a threshold is met, the processor then determines the appropriate action to take 612.

In determining the action to be taken 612, the processor can take a number of factors into consideration including, for example, cost, resource availability, downtime, etc. The importance (i.e. weighting) of each factor to the determination can be adjusted depending on which of the above described defined outcomes (to maximise the life of the component, to maximise the efficiency of the component, and to operate the machine at its maximum capacity or performance) is desired. One action 614 that can be taken, for example if the processor predicts a low remaining useful life for a component, is the replacement of a component. In this case, the replacement component can be produced according by an additive manufacturing facility, such as in the above described system illustrated in FIG. 5. Alternatively, and as is also discussed above, the action 614 taken may be in the form of an adjustment of an operating parameter of the machine e.g. to increase the remaining useful life of the machine or to increase the performance of the machine. The action 614 may be performed automatically, or can be performed manually by an operator (i.e. the processor may indicate a recommended action to the operator).

Once the action is taken data regarding the outcome 616 may optionally become part of the historical data (i.e. by appending the data to the historical dataset, along with the sensed data prior to the outcome). In this way, the database of historical data 604 can be continuously added to. The outcome data can include an indication of whether the prediction and determined action were appropriate. In this way, the outcome data can be used to adjust, for improvement, the various processes performed by the processor.

It should be apparent to the skilled person that other method may be used to identify the components for replacement. One such method may be the use of a machine learning algorithm in order to predict the effects on a machine of replacing a component (using historical data regarding such effects). This prediction can be used to select an appropriate component for replacement. Again, various factors (such as cost, lead time and availability) can also be used to make this selection.

Variations and modifications may be made to the parts previously described without departing from the spirit or ambit of the disclosure.

For example the embodiments described above relate to minerals processing operations. However, the method is applicable to other operations (e.g. oil and gas, manufacturing, power generation) where a number of parameters of a machine require monitoring.

The system architecture described above is just one example of how the method may be implemented. As is set forth above, the sensors may alternatively communicate with a single machine module.

The criteria, which in the above embodiments are ranges of values, may alternatively be dictated by functions or may be a comparison with a changing value that is e.g. dependent on the operation of the machine. For example, the criteria may be whether the measured variable matches another measured variable.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A method for monitoring the operation of a machine, the method comprising:
measuring a plurality of parameters of the machine to obtain a plurality of measured values;
combining one or more of the values of the measured parameters to generate combined values;
transforming the combined values to generate a plurality of normalised indicator values; and
combining the normalised indicator values to indicate a condition of the machine.

2. (canceled)

3. The method according to claim 1, further comprising the step of controlling the machine in response to the indicated condition of the machine.

4. The method according to claim 1, wherein the step of controlling the machine comprises an automatic adjustment of one or more operating parameters of the machine, by a controller, in response to the indicated condition of the machine.

5. (canceled)

6. The method according to claim 1, wherein the step of transforming the combined values comprises testing each combined value against a respective set of predetermined criteria, each comprising one or more predetermined ranges of values, to determine whether each combined value falls within one of the predetermined ranges of values.

7. The method according to claim 6 wherein each criteria corresponds to an indicator value, the generated indicator values being those corresponding to criteria satisfied by the or combined value.

8. The method according to claim 7 wherein the criteria and corresponding indicator values are adjusted upon completion of the method for subsequent repeat execution of the method.

9. A The method according to claim 1, wherein the indicator values are indicative of an effect on a health condition of the machine, and the indicated condition is a current health level of the machine.

10. A system for monitoring a machine, the system comprising:
a plurality of sensors, each sensor measuring a parameter of the machine and providing data indicative or the measured value of the parameter;
a processor configured to:
receive the measured value data
generate combined value data from the measured value data;
transform the combined value data to generate a plurality of normalised indicator values; and
combine the normalised indicator values to indicate a condition of the machine.

11. The system according to claim 10 further comprising a controller to control the machine in response to the indicated condition of the machine.

12. The system according to claim 10 wherein the processor is configured to generate the normalised indicator values by a comparison of the combined values with a set of predetermined criteria.

13. A machine comprising:
a plurality of machine functions;
a plurality of sensors measuring parameters of the respective machine functions and producing data indicative of the measured values of those parameters;
a visual display providing a visual scale representing conditions of the machine; and
a processor that indicates a current condition by, in response to the measured values from the plurality of the machine components,
combining the measured values into combined values,
transforming the combined values to generate a plurality of normalised indicator values, and
wherein the normalised indicator values indicate the current condition of the machine on said visual scale.

14. The machine according to claim 13 wherein the plurality of machine functions comprises one or more components of the machine and/or processes of the machine.

15-21. (canceled)

22. The method according to claim 3, wherein the step of controlling the machine comprises an automatic adjustment of one or more operating parameters of the machine, by a controller, in response to the indicated condition of the machine.

23. The method according to claim 3, wherein the step of transforming the combined values comprises testing each combined value against a respective set of predetermined criteria, each comprising one or more predetermined ranges of values, to determine whether each combined value falls within one of the predetermined ranges of values.

24. The method according to claim 4, wherein the step of transforming the combined values comprises testing each combined value against a respective set of predetermined criteria, each comprising one or more predetermined ranges of values, to determine whether each combined value falls within one of the predetermined ranges of values.

25. The method according to claim 3, wherein the indicator values are indicative of an effect on a health condition of the machine, and the indicated condition is a current health level of the machine.

26. The method according to claim 4, wherein the indicator values are indicative of an effect on a health condition of the machine, and the indicated condition is a current health level of the machine.

27. The method according to claim 6, wherein the indicator values are indicative of an effect on a health condition of the machine, and the indicated condition is a current health level of the machine.

28. The method according to claim 7, wherein the indicator values are indicative of an effect on a health condition of the machine, and the indicated condition is a current health level of the machine.

29. The system according to claim 11, wherein the processor is configured to generate the normalised indicator values by a comparison of the combined values with a set of predetermined criteria.
